(19) United States
(12) Patent Application Publication
(10) Pub. No.: US 2025/0377143 A1
(43) Pub. Date: Dec. 11, 2025

(54) THERMAL OPTIC DETECTION OF REFRIGERANT LEAKS

(71) Applicant: VERTIV CORPORATION, Westerville, OH (US)

(72) Inventors: COLIN LEWIS BLASER, Westerville, OH (US); THOMAS CHRISTOPHER BREUER, New Albany, OH (US); JEREMY RYAN KING, Delaware, OH (US)

(73) Assignee: VERTIV CORPORATION, Westerville, OH (US)

(21) Appl. No.: 19/231,361

(22) Filed: Jun. 6, 2025

Related U.S. Application Data
(60) Provisional application No. 63/657,682, filed on Jun. 7, 2024.

(51) Int. Cl. F25B 49/00; F24F 11/36; G01M 3/00

(52) U.S. Cl. CPC F25B 49/005; F24F 11/36; G01M 3/002; F25B 2500/222

(57) ABSTRACT

An apparatus can include an optical sensor and a controller configured to monitor the optical sensor and provide an indication of a refrigerant leak. The optical sensor can view at least a portion of an evaporator, a condenser, a prime mover, associated plumbing, or any combination thereof. The optical sensor can be a thermal optical sensor, such as those using infrared imaging technology. The optical sensor can provide an indication of different temperatures across a field of view of the optical sensor. The controller can analyze the different temperatures across the field of view and identify a cold spot and/or a temperature gradient in the field of view.

### CROSS REFERENCE TO RELATED APPLICATIONS

This application claims the benefit of U.S. Provisional Patent Application No. 63/657,682 filed Jun. 7, 2024, the entire contents of which are incorporated herein by reference.

### TECHNICAL FIELD

The present disclosure relates generally to refrigerant-based cooling units and more specifically relates to refrigerant leak detection in such units typically used in data centers.

### BACKGROUND

Refrigerant leaks pose a great risk for the efficiency of units used to cool data centers. Data centers have a critical need for quick detection and identification of leaks within such cooling units. Systematic leak detection can reduce downtime and save money by facilitating the continuity of the data center. However, current leak detection sensors do not effectively pinpoint the location of the leak and are reliant on a buildup of concentration before alarming.

### SUMMARY

Applicant has created new and useful devices, systems and methods for leak detection in refrigerant-based cooling units, such as those used in data centers. Embodiments of the disclosure can advantageously provide for fast and effective leak detection as well as an accurate determination of the source or location of a leak. Consequently, embodiments of the disclosure increase cooling system efficiency, decrease the chance of catastrophic equipment failure, and decrease cooling system downtime.

In at least one embodiment, an apparatus according to the disclosure can detect a refrigerant leak in a cooling system configured to circulate refrigerant through plumbing between an evaporator and a condenser using a prime mover. In at least one embodiment, the apparatus can include an optical sensor and a controller configured to monitor the optical sensor and provide an indication of the refrigerant leak. In at least one embodiment, the optical sensor can view at least a portion of the evaporator, the condenser, the prime mover, the plumbing, or any combination thereof. In at least one embodiment, the optical sensor can be a thermal optical sensor, such as an infrared imaging sensor.

In at least one embodiment, the optical sensor can provide an indication of different temperatures across a field of view of the optical sensor. In at least one embodiment, the field of view can include at least a portion of the evaporator, the condenser, the prime mover, the plumbing, or any combination thereof. In at least one embodiment, the indication of the refrigerant leak can be based on the field of view. In at least one embodiment, the indication of the refrigerant leak can reflect the field of view. In at least one embodiment, the controller can analyze the different temperatures across the field of view of the optical sensor and identify a cold spot in the field of view.

In at least one embodiment, the controller can identify the cold spot as having an increasing temperature gradient. In at least one embodiment, the controller can identify the cold spot as having a temperature gradient of at least 50 degrees Fahrenheit per inch. In at least one embodiment, the controller can identify the cold spot as having a temperature gradient of at least 10 degrees Fahrenheit per inch around a 360-degree perimeter. In at least one embodiment, the controller can identify the cold spot as having a decreasing temperature while surrounding portions of the field of view increase in temperature.

In at least one embodiment, the controller can control, based at least in part upon information received from the optical sensor, the prime mover, a valve of the plumbing, a fan of the evaporator, a fan of the condenser, or any combination thereof. In at least one embodiment, the controller can provide a live video feed of the refrigerant leak, such as upon detection of the refrigerant leak.

In at least one embodiment, a cooling system according to the disclosure can include a prime mover configured to circulate refrigerant through plumbing, an evaporator, and a condenser, and one or more thermal optical sensors for monitoring one or more portions of the system and detecting one or more refrigerant leaks therein. In at least one embodiment, the system can include a controller configured to monitor an indication of different temperatures across a field of view of the one or more thermal optical sensors and provide an indication of a refrigerant leak based at least in part on a temperature difference. In at least one embodiment, the field of view can include at least a portion of the prime mover, the plumbing, the evaporator, the condenser, or any combination thereof.

In at least one embodiment, the controller can analyze different temperatures across the field of view of an optical sensor and identify a refrigerant leak as a cold spot in the field of view. In at least one embodiment, the controller can analyze different temperatures across the field of view of the optical sensor and identify a cold spot in the field of view as having a temperature gradient. In at least one embodiment, the controller can analyze different temperatures across the field of view of the optical sensor over time and during different operating modes. In at least one embodiment, the controller can identify the refrigerant leak as a cold spot in the field of view having an abnormal temperature gradient.

### BRIEF DESCRIPTION OF THE DRAWINGS

FIG. 1 is a perspective view of one of many embodiments of a refrigerant-based cooling unit according to the disclosure.

FIG. 2 is a perspective view of another of many embodiments of a refrigerant-based cooling unit according to the disclosure.

FIG. 3 is a schematic view of one of many embodiments of a refrigerant-based cooling unit having a leak detection system according to the disclosure.

FIG. 4 is a schematic view of another of many embodiments of a refrigerant-based cooling unit having a leak detection system according to the disclosure.

FIG. 5 is a perspective view of a portion of one of many embodiments of a refrigerant-based cooling unit having a leak detection system according to the disclosure.

FIG. 6 is an exemplary representation of a refrigerant leak shown on a display of a leak detection system according to the disclosure.

### DETAILED DESCRIPTION

The figures described above and the written description of specific structures and functions below are not presented to limit the scope of what Applicant has invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Applicant has created new and useful devices, systems and methods for leak detection in refrigerant-based cooling units, such as those used in data centers. Embodiments of the disclosure can advantageously provide for fast and effective leak detection as well as an accurate determination of the source or location of a leak. Consequently, embodiments of the disclosure increase cooling system efficiency, decrease the chance of catastrophic equipment failure, and decrease cooling system downtime.

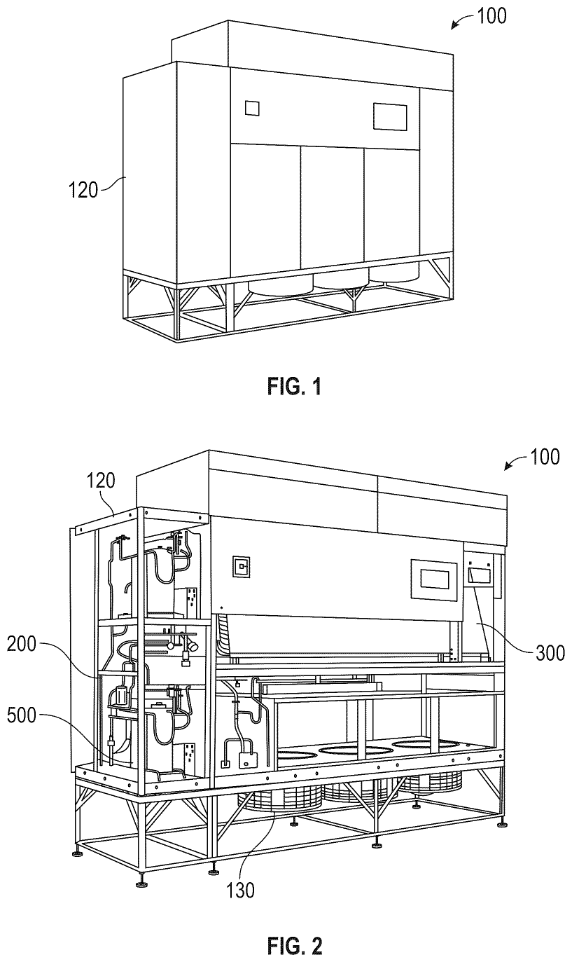

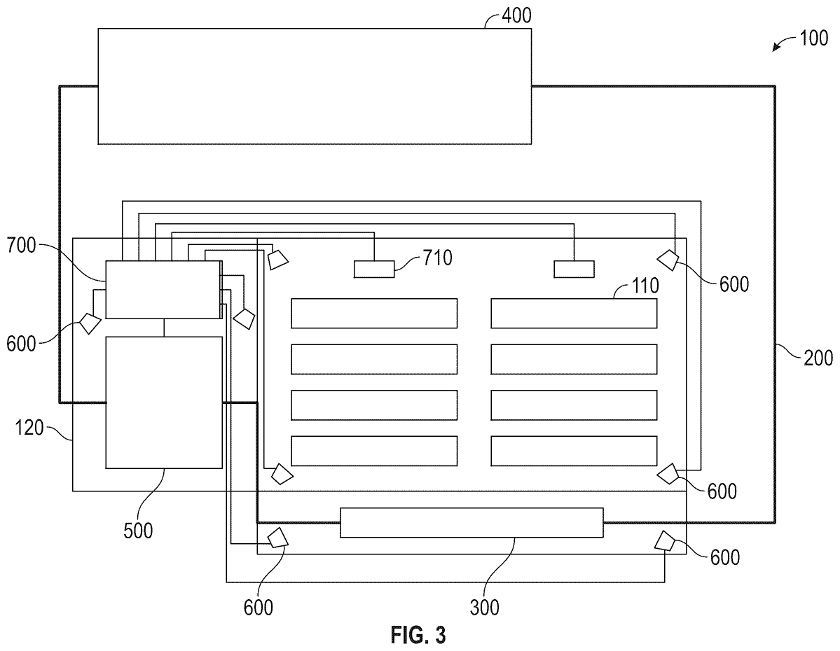

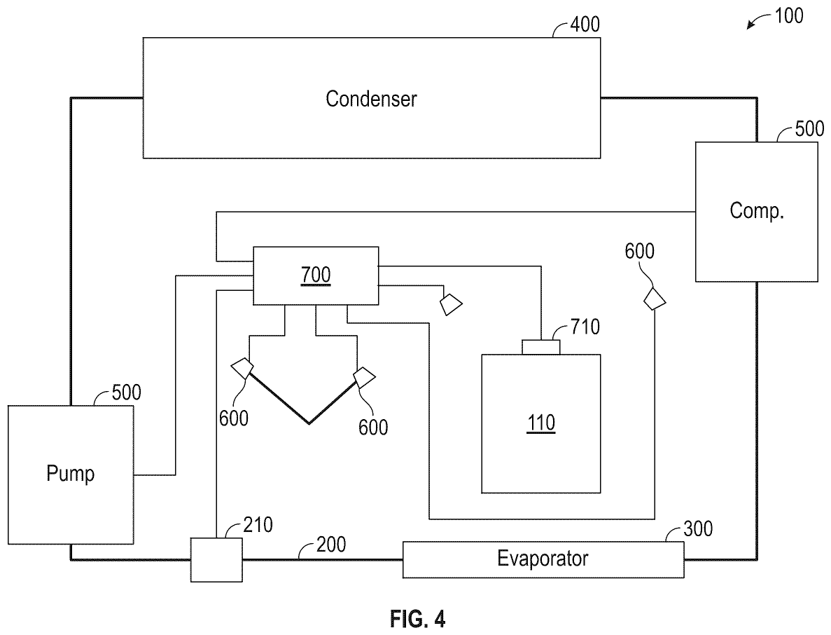

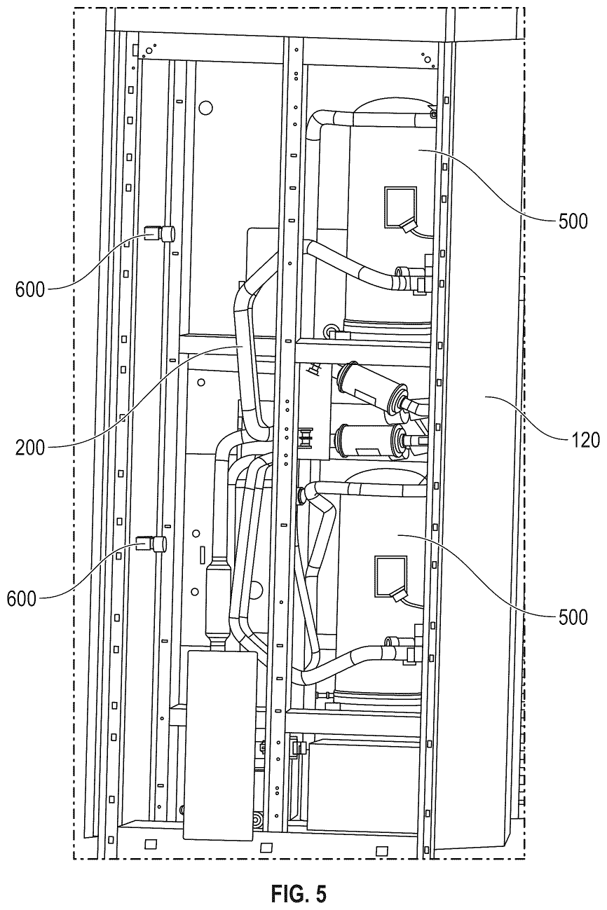

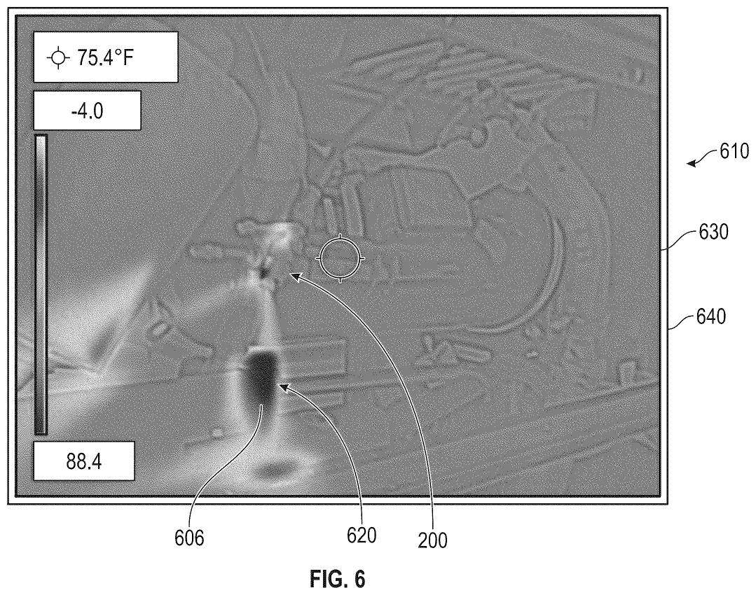

FIG. 1 is a perspective view of one of many embodiments of a refrigerant-based cooling unit according to the disclosure. FIG. 2 is a perspective view of another of many embodiments of a refrigerant-based cooling unit according to the disclosure. FIG. 3 is a schematic view of one of many embodiments of a refrigerant-based cooling unit having a leak detection system according to the disclosure. FIG. 4 is a schematic view of another of many embodiments of a refrigerant-based cooling unit having a leak detection system according to the disclosure. FIG. 5 is a perspective view of a portion of one of many embodiments of a refrigerant-based cooling unit having a leak detection system according to the disclosure. FIG. 6 is an exemplary representation of a refrigerant leak shown on a display of a leak detection system according to the disclosure. FIGS. 1-6 are described in conjunction with one another.

In at least one embodiment, the cooling system 100 can include a refrigerant-based cooling loop and an apparatus for detecting and/or indicating a location of a refrigerant leak in one or more portions of the cooling loop. For example, in at least one embodiment, the system 100 can include one or more prime movers 500, such as a pump or compressor, for circulating refrigerant through plumbing 200 between one or more evaporators 300 and one or more condensers 400 in order to extract heat from the evaporator 300 and reject heat via the condenser 400. In at least one embodiment, the evaporator 300 can extract heat from one or more heat loads 110, such as computing and/or networking devices commonly housed in data center cabinets 120 and the like.

In at least one embodiment, the apparatus for detecting a refrigerant leak in the cooling system 100 can include one or more optical sensors 600 and one or more controllers 700 operably coupled thereto. In at least one embodiment, a controller 700 can monitor an optical sensor 600 and provide one or more indications of a refrigerant leak sensed by the optical sensor 600. In at least one embodiment, the optical sensor 600 can view at least a portion of the evaporator 300, the condenser 400, the prime mover 500, the plumbing 200, or any combination thereof. For example, refrigerant leaks often occur in connections within the plumbing 200 or between the plumbing 200 and the evaporator 300, the condenser 400, the prime mover 500, or any combination thereof. Thus, in at least one embodiment, the optical sensor 600 can be oriented to monitor one or more connection points in a refrigerant loop of the system 100. In at least one embodiment, the optical sensor 600 can be a thermal optical sensor, such as those using infrared imaging technology.

In at least one embodiment, the optical sensor 600 can provide an indication of different temperatures across a field of view 610 of the optical sensor 600, such as by way of a graphical user interface 630 of a display 640. In at least one embodiment, the field of view 610 can include at least a portion of the evaporator 300, the condenser 400, the prime mover 500, the plumbing 200, or any combination thereof. In at least one embodiment, the indication of the refrigerant leak can be based on the field of view 610. In at least one embodiment, the indication of the refrigerant leak can reflect the field of view 610. For example, in at least one embodiment, the controller 700 can provide a live video feed of the field of view 610 of the optical sensor 600 and/or the refrigerant leak, such as upon detection of the refrigerant leak. Alternatively, or collectively, the controller 700 can provide one or more still images of the field of view 610 of the optical sensor 600 and/or the refrigerant leak. In this manner, the system 100 can provide a user with not only an indication that a leak exists, but also an indication of precisely where in the system 100 the leak exists.

In at least one embodiment, the controller 700 can analyze different temperatures across the field of view 610 of the optical sensor 600 and identify a cold spot 606 in the field of view 610. For example, as best shown in the exemplary illustration of FIG. 6, the cold spot 606 can be exhibited by a temperature gradient 620 and the controller 700 can identify the temperature gradient 620 as indicative of a refrigerant leak. In at least one embodiment, the controller 700 can identify the cold spot 606 as having an increasing temperature gradient 620. For example, leaking refrigerant can be colder than surrounding space or structure within the cabinet 120. In at least one embodiment, the refrigerant leak can impinge upon the cabinet 120 and/or its contents, which can cause the surrounding structure within the cabinet 120 to become cooler than one or more other portions of the cabinet 120. In at least one embodiment, such a cooling effect can cause a thermally visible temperature gradient 620, which can increase as the leak persists or worsens. In at least one embodiment, the controller can determine that a leak exists based on the temperature gradient 620 and/or a change in the temperature gradient 620 over time.

In at least one embodiment, the controller 700 can identify the cold spot 606 (see, e.g., FIG. 6) as having a temperature gradient 620 of at least 10 degrees Fahrenheit per inch. In at least one embodiment, the controller 700 can identify the cold spot 606 as having a temperature gradient 620 of at least 25 degrees Fahrenheit per inch. In at least one embodiment, the controller 700 can identify the cold spot 606 as having a temperature gradient 620 of at least 50 degrees Fahrenheit per inch. In at least one embodiment, the controller 700 can identify the cold spot 606 as having a temperature gradient 620 of at least 10 degrees Fahrenheit per inch around a 360-degree perimeter or boundary. In at least one embodiment, the controller 700 can identify the cold spot 606 as having a temperature gradient 620 of at least 20 degrees Fahrenheit per inch around a 360-degree perimeter. In at least one embodiment, the controller 700 can identify the cold spot 606 as having a temperature gradient 620 of at least 40 degrees Fahrenheit per inch around a 360-degree perimeter. In at least one embodiment, the controller 700 can identify the cold spot 606 as having a decreasing temperature while surrounding portions of the field of view 610 increase in temperature, such as due to equipment operating in the absence of adequate or otherwise expected cooling.

As will be understood by a person of ordinary skill in the art having the benefits of the present disclosure, the exemplary thermal image of FIG. 6 is but one of many, and is included herein for purposes of illustration and not limitation. For instance, while the lowest temperature reflected in FIG. 6 is −4.0 degrees Fahrenheit and the highest temperature reflected in FIG. 6 is 88.4 degrees Fahrenheit, such examples are merely some of many and reflect temperatures associated with but a single real-world implementation of the disclosure. In this particular case, the thermal camera or sensor utilized had a lower temperature limit of −4.0 degrees Fahrenheit and the highest temperature at the time of the exemplary screenshot just happened to be 88.4 degrees Fahrenheit. As will be understood by a person of ordinary skill in the art having the benefits of the present disclosure, other thermal cameras or sensors exist and may come to exist in the future, and any camera(s), sensor(s) and/or temperature range(s) can be utilized as required or desired for a given implementation of the disclosure. For example, when R454B refrigerant (aka A2L refrigerant) leaks and makes contact with atmospheric pressure, the temperature can drop to roughly−60 degrees Fahrenheit and, in at least one embodiment, the thermal optical sensor 600 can have a lower temperature limit at or below −60 degrees Fahrenheit and/or a high temperature limit at or above 140 degrees Fahrenheit.

In at least one embodiment, the controller 700 can control the prime mover 500, a valve 210 of the plumbing 200, a fan 130 (e.g., of the evaporator 300 or the condenser 400), or any combination thereof, based on a conventional temperature sensor 710. In at least one embodiment, the controller 700 can control, based at least in part on information received from the optical sensor 600, the prime mover 500, a valve 210 of the plumbing 200, a fan 130 (e.g., of the evaporator 300 or the condenser 400), or any combination thereof. For example, in at least one embodiment, the controller 700 can shut down the system 100 or a portion thereof, such as by turning off the prime mover 500 and/or closing the valve 210, upon detecting the leak. In at least one embodiment, the optical sensor 600 can supplement or replace the conventional temperature sensor 710, and the controller 700 can control the prime mover 500, a valve 210 of the plumbing 200, a fan 130 of the evaporator 300, a fan 130 of the condenser 400, or any combination thereof, based at least partially on a signal from the optical sensor 600.

In at least one embodiment, the cooling system 100 can circulate refrigerant through plumbing 200 between one or more evaporators 300 and one or more condensers 400 in order to extract heat from the evaporator 300 and reject heat via the condenser 400, and can include one or more thermal optical sensors 600 disposed in sensing communication with a corresponding portion(s) of the system 100. In at least one embodiment, the cooling system 100 can include one or more prime movers 500, such as one or more pumps and/or compressors, for circulating refrigerant through the plumbing 200, the evaporator 300, and the condenser 400, and one or more thermal optical sensors 600. A thermal optical sensor 600 can have a field of view 610 and one or more controllers 700 can monitor an indication of different temperatures across the field of view 610 and provide one or more indications of a refrigerant leak based at least in part thereon, such as a visual indication, audible indication, or both. In at least one embodiment, the field of view 610 can include at least a portion of the prime mover 500, the plumbing 200, the evaporator 300, the condenser 400, or any combination thereof. For example, one or more thermal optical sensors 600 can be coupled to a cabinet 120 and disposed in sensing communication with one or more of the foregoing components and/or connections therebetween.

In at least one embodiment, the controller 700 can analyze the different temperatures across the field of view 610 of the optical sensor 600 and identify the refrigerant leak as a cold spot 606 in the field of view 610. In at least one embodiment, the controller 700 can analyze the different temperatures across the field of view 610 of the optical sensor 600 and identify a cold spot 606 in the field of view 610 as having a temperature gradient 620. In at least one embodiment, the controller 700 can analyze the different temperatures across the field of view 610 of the optical sensor 600 over time and/or during different operating modes. In at least one embodiment, the controller 700 can identify the refrigerant leak as a cold spot 606 in the field of view 610 as exhibited by an abnormal temperature gradient 620.

In at least one embodiment, an apparatus according to the disclosure, such as an apparatus for detecting a refrigerant leak in a cooling system, can include one or more optical sensors for being disposed in sensing communication with one or more refrigerant-containing components and one or more controllers for monitoring the optical sensor(s) and providing an indication of a refrigerant leak. In at least one embodiment, the apparatus can provide an indication that a refrigerant leak exists, an indication of the location of the refrigerant leak, or both. In at least one embodiment, the optical sensor can view at least a portion of the evaporator, the condenser, the prime mover, the plumbing, or any combination thereof. In at least one embodiment, the optical sensor can be a thermal optical sensor, such as an infrared imaging sensor.

In at least one embodiment, the optical sensor can provide an indication of different temperatures across a field of view of the optical sensor. In at least one embodiment, the field of view can include at least a portion of the evaporator, the condenser, the prime mover, the plumbing, or any combination thereof. In at least one embodiment, the indication of the refrigerant leak can be based on the field of view. In at least one embodiment, the indication of the refrigerant leak can reflect or include the field of view. In at least one embodiment, the controller can analyze different temperatures across the field of view of the optical sensor and identify a cold spot in the field of view.

In at least one embodiment, the controller can identify the cold spot as having or exhibiting an increasing temperature gradient. In at least one embodiment, the controller can identify the cold spot as having a temperature gradient of at least 50 degrees Fahrenheit per inch. In at least one embodiment, the controller can identify the cold spot as having a temperature gradient of at least 10 degrees Fahrenheit per inch around a 360-degree perimeter. In at least one embodiment, the controller can identify the cold spot as having a decreasing temperature while surrounding portions of the field of view increase in temperature.

In at least one embodiment, the controller can control, based at least in part upon information received from the optical sensor, the prime mover, a valve of the plumbing, a fan of the evaporator, a fan of the condenser, or any combination thereof. In at least one embodiment, the controller can provide a video or image feed of the refrigerant leak, such as upon detection of the refrigerant leak.

In at least one embodiment, a cooling system according to the disclosure can circulate refrigerant through plumbing between an evaporator and a condenser in order to extract heat from the evaporator and reject the heat through the condenser. In at least one embodiment, a cooling system according to the disclosure can include a prime mover for circulating refrigerant through the plumbing, the evaporator, and the condenser, a thermal optical sensor configured to provide an indication of different temperatures across a field of view, a controller configured to monitor the indication of different temperatures across the field of view and provide an indication of a refrigerant leak based at least in part thereon, or any combination thereof. In at least one embodiment, the field of view can include at least a portion of the prime mover, the plumbing, the evaporator, the condenser, or any combination thereof.

In at least one embodiment, the controller can analyze different temperatures across the field of view of the optical sensor and identify the refrigerant leak as a cold spot in the field of view. In at least one embodiment, the controller can analyze the different temperatures across the field of view of the optical sensor and identify a cold spot in the field of view as having a temperature gradient. In at least one embodiment, the controller can analyze the different temperatures across the field of view of the optical sensor over time and during different operating modes. In at least one embodiment, the controller can identify the refrigerant leak as a cold spot in the field of view having an abnormal temperature gradient.

Other and further embodiments utilizing one or more aspects of the disclosure can be devised without departing from the spirit of Applicant's disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicant, but rather, in conformity with the patent laws, Applicant intends to fully protect all such modifications and improvements that come within the scope or range of equivalents of the following claims.

What is claimed is:

1. An apparatus for detecting a refrigerant leak in a cooling system configured to circulate refrigerant through plumbing between an evaporator and a condenser using a prime mover, the apparatus comprising:
an optical sensor configured to be disposed in sensing communication with at least a portion of at least one of the evaporator, the condenser, the prime mover, the plumbing, or a combination thereof; and
a controller configured to monitor the optical sensor and provide an indication of the refrigerant leak.

2. The apparatus of claim 1, wherein the optical sensor is a thermal optical sensor.

3. The apparatus of claim 1, wherein the optical sensor is configured to provide an indication of different temperatures across a field of view of the optical sensor.

4. The apparatus of claim 3, wherein the field of view includes at least a portion of at least one of the evaporator, the condenser, the prime mover, the plumbing, or a combination thereof.

5. The apparatus of claim 3, wherein the field of view includes at least a portion of the plumbing and at least a portion of at least one of the evaporator, the condenser, or the prime mover.

6. The apparatus of claim 3, wherein the indication of the refrigerant leak is based on the field of view.

7. The apparatus of claim 3, wherein the indication of the refrigerant leak reflects the field of view.

8. The apparatus of claim 3, wherein the controller is further configured to analyze the different temperatures across the field of view of the optical sensor and identify a cold spot in the field of view.

9. The apparatus of claim 8, wherein the controller is further configured to identify the cold spot as having an increasing temperature gradient.

10. The apparatus of claim 8, wherein the controller is further configured to identify the cold spot as having a temperature gradient of at least 50 degrees Fahrenheit per inch.

11. The apparatus of claim 8, wherein the controller is further configured to identify the cold spot as having a temperature gradient of at least 10 degrees Fahrenheit per inch around a 360-degree perimeter.

12. The apparatus of claim 8, wherein the controller is further configured to identify the cold spot as having a decreasing temperature while surrounding portions of the field of view increase in temperature.

13. The apparatus of claim 1, wherein the controller is further configured to control the prime mover based at least in part on information received from the optical sensor.

14. The apparatus of claim 1, wherein the controller is further configured to control a valve of the plumbing based at least in part on information received from the optical sensor.

15. The apparatus of claim 1, wherein the controller is further configured to output a live video feed of the refrigerant leak to a display.

16. The apparatus of claim 1, wherein the controller is further configured to output a live video feed of the refrigerant leak to a display upon detection of the refrigerant leak.

17. A cooling system configured to circulate a refrigerant through plumbing between an evaporator and a condenser in order to extract heat from the evaporator and reject the heat via the condenser, the system comprising:
a prime mover configured to circulate the refrigerant through the plumbing, the evaporator, and the condenser;
a thermal optical sensor configured to provide an indication of different temperatures across a field of view, wherein the field of view includes at least a portion of at least one of the prime mover, the plumbing, the evaporator, the condenser, or a combination thereof; and
a controller configured to monitor the indication of different temperatures across the field of view and provide an indication of a refrigerant leak based at least in part on the indication of different temperatures across the field of view.

18. The system of claim 17, wherein the controller is further configured to analyze the different temperatures across the field of view of the optical sensor and identify a cold spot in the field of view as having a temperature gradient.

19. The system of claim 17, wherein the controller is further configured to:
analyze the different temperatures across the field of view of the optical sensor over time and during a plurality of different operating modes of the cooling system; and
identify the refrigerant leak as a cold spot in the field of view having an abnormal temperature gradient.

20. An apparatus for detecting a refrigerant leak in a cooling system having a refrigerant loop, the apparatus comprising:
one or more optical sensors configured to be mounted to a cabinet in sensing communication with at least a portion of the refrigerant loop; and
a controller configured to monitor the one or more optical sensors;
wherein the apparatus is configured to, upon detection of the refrigerant leak, provide an indication of the refrigerant leak and an image of a location of the refrigerant leak.
